(19) United States
(12) Patent Application Publication
(10) Pub. No.: US 2026/0273958 A1
(43) Pub. Date: Sep. 17, 2026

(54) INKJET DIGITAL PRINTING MACHINE FOR PRINTING ON CAPSULES

(71) Applicant: QUANTIX DIGITAL S.r.I., Vigevano (Pavia) (IT)

(72) Inventors: Flavio VAILATI, Caravaggio (Bergamo) (IT); Paolo VENTURELLI, Milano (IT)

(73) Assignee: QUANTIX DIGITAL S.r.I., Vigevano (Pavia) (IT)

(21) Appl. No.: 19/471,317

(22) PCT Filed: Feb. 7, 2024
(86) PCT No.: PCT/EP2024/052979

§ 371 Date: Sep. 30, 2025

(30) Foreign Application Priority Data
Mar. 31, 2023 (IT) 102023000006402

(51) Int. Cl. B41J 3/407; B41J 3/54; B41J 11/00; B41J 13/00; B41J 13/22

(52) U.S. Cl. CPC B41J 3/40733; B41J 3/40731; B41J 3/543; B41J 11/0095; B41J 13/0027; B41J 13/223

(57) ABSTRACT

Digital inkjet printing machine for printing on the at least one capsule comprising a tubular mantle and a closing head, comprising a conveyance table, at least one first printing station equipped with at least one first printhead dedicated to printing on the tubular mantle and at least one second printing station equipped with at least one second printhead dedicated to printing on the closing head, wherein the convenyance table is programmed to rotate in steps about a rotation axis and supports at least one support spindle of the capsule, wherein the conveyance table is configured to transport the spindle at the at least one first printing station and at the at least one second printing station, wherein a controller is programmed to operate in rotation about its own axis the spindle in stationary position at the at least one first printing station, and to stop rotation about its own axis of the spindle at the at least one second printing station.

The present invention relates to an ink-jet digital printing machine for printing on capsules of the type comprising a tubular mantle and a closing head of one end of the tubular mantle.

The field of interest includes metal or plastic capules that are generally applied as caps or closures, e.g. but not limited to screw caps for bottles.

Traditionally, digital or analogue printing technology, e.g. screen printing, offset or flexo, can be used to print various outer surfaces.

If digital ink-jet printing technology is used, there is usually a printing machine for printing on the tubular mantle and an additional printing machine for printing on the closing head.

If analogue printing technology is used, on the other hand, printing on the various surfaces can be achieved with a single printing machine. The orientation of the printing on the various surfaces can be achieved with the help of special sensors, e.g. encoders or position sensors, which create spatial references for the oriented printing on the next surface to be printed after printing on one surface.

One of the drawbacks of known printing processes is that it is generally not possible to print on the edges between adjacent surfaces, with the consequence that prints applied on adjacent surfaces of the print substrate may be disjointed and consequently penalise the aesthetics of the product.

The technical task proposed by the present invention is, therefore, to eliminate the complained of technical drawbacks of the known technique.

In the context of this technical task, one scope of the invention is to provide a printing machine that makes it possible to perform a not disjointed printing on the outer surfaces of a capsule.

Another purpose of the invention is to provide a printing machine that makes it possible to orient the print on the outer surfaces of a capsule.

Another aim of the invention is to create a printing machine that combines versatility, print quality and production capacity.

The technical task, as well as these and other purposes, according to the present invention are achieved by realizing a digital inkjet printing machine for printing on at least one capsule formed by a tubular mantle and a closing head, characterized in that it comprises an electronic controller, a conveyor table, at least a first printing station provided with at least a first printing head dedicated to printing on said tubular mantle and at least a second printing station provided with at least a second printing head dedicated to printing on said closing head, wherein said conveyor table is programmed to rotate in steps around a rotation axis and supports at least one support spindle of said at least one capsule, wherein said at least one support spindle has an axis oriented radially with respect to said rotation axis of said conveyor table, wherein said conveyor table is configured to convey said at least one spindle at said at least a first printing station and at said at least a second printing station, wherein said controller is programmed to drive rotatingly about its axis said at least one spindle stationing at said at least a first printing station, and to block the rotation about its axis of said at least one spindle at said at least a second printing station.

Advantageously, said controller is programmed to clamp a capsule on said at least one spindle, to drive rotatingly about its axis said at least one spindle stationing at said at least a first printing station with the clamped capsule threon and, after said at least one spindle with the clamped capsule is conveyed from said first printing station to said second printing station, to block the rotation about its axis of said at least one spindle with the clamped capsule threon at said at least a second printing station.

Any suitable clamping means can be foreseen to clamp the capsule on the spindle.

Preferreded embodiments of clamping means are shown in detail in the following description.

Advantageously, this controller automatically knows the angular position of the spindle around its own axis, as it programs its movement, and uses this knowledge to orient the printing of the mantle with respect to the printing of the closing head or vice versa.

Preferably this conveyor table has a vertical axis of rotation.

Preferably said at least one first head is horizontally oriented.

Advantageously said at least one first head is programmed to print stationary and said at least one second head is programmed to print stationary or in motion.

In a mode of embodiment of the invention said at least one second head is programmed to print from a stationary position while said at least one spindle with capsule is in transit through said second printing station.

In a mode of embodiment of the invention said at least one second head is programmed to print in motion while said at least one spindle with capsule is stationary in said second printing station.

In such a case, said at least one second head is programmed to print during the execution of a horizontal or vertical linear movement while said at least one spindle is stationary in said second printing station.

Other features of the present invention are also defined in subsequent claims.

The digital inkjet machine utilises a non-contact printing technology that makes it easy to orient the print and print correctly even on the joining edges between non-coplanar surfaces.

The printing machine can be flexibly adapted to produce more elaborate prints and/or more complex finishes by simply increasing the number and type of stations arranged around the rotary table.

Further features and advantages of the invention will become more apparent from the description of a preferred but non-exclusive form of execution of the digital inkjet printing machine according to the invention, illustrated by way of illustration and not limitation in the accompanying drawings, in which

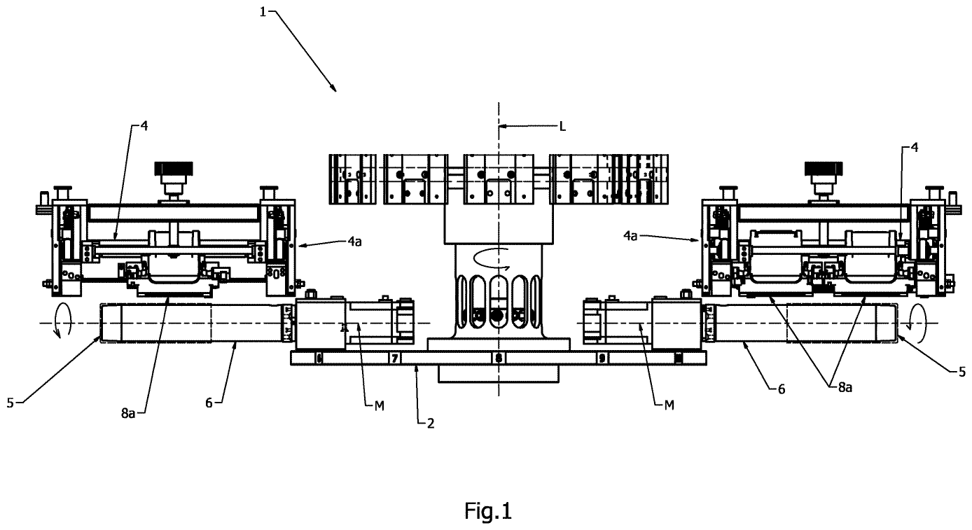

FIG. 1 shows a side elevation view of a possible printing machine layout where only a few first printing stations are shown for convenience;

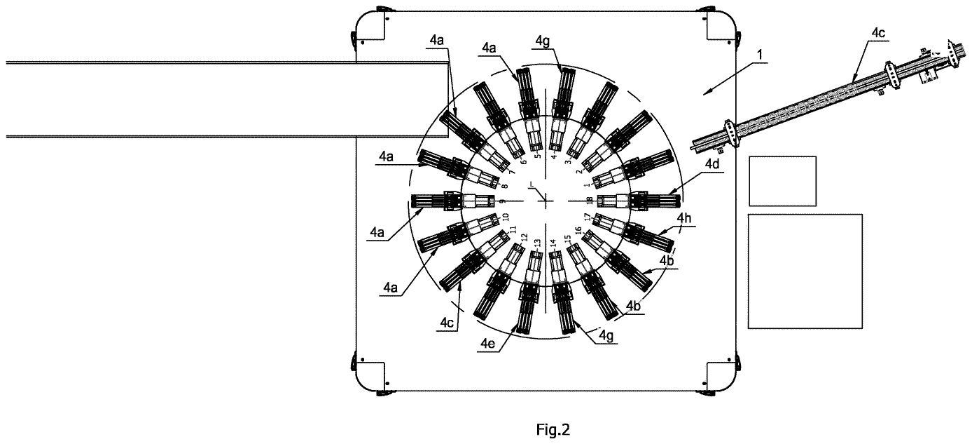

FIG. 2 shows a plan view of a possible printing machine layout;

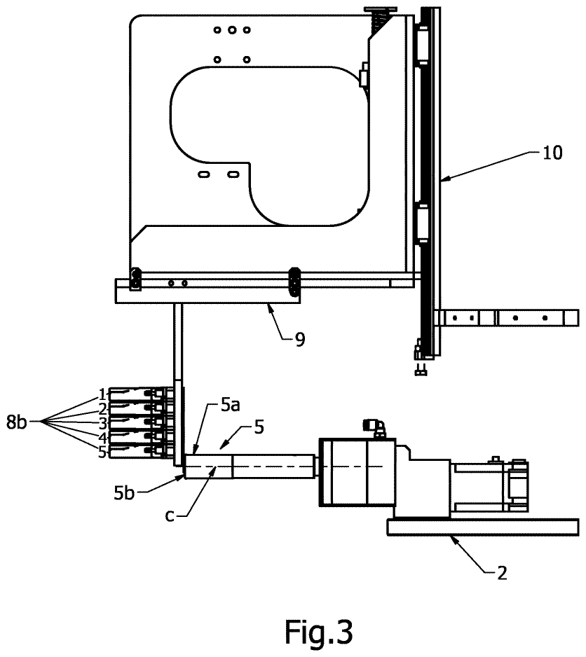

FIG. 3 shows a side elevation view of a second printing station with the carriage in an elevated position assumed prior to printing;

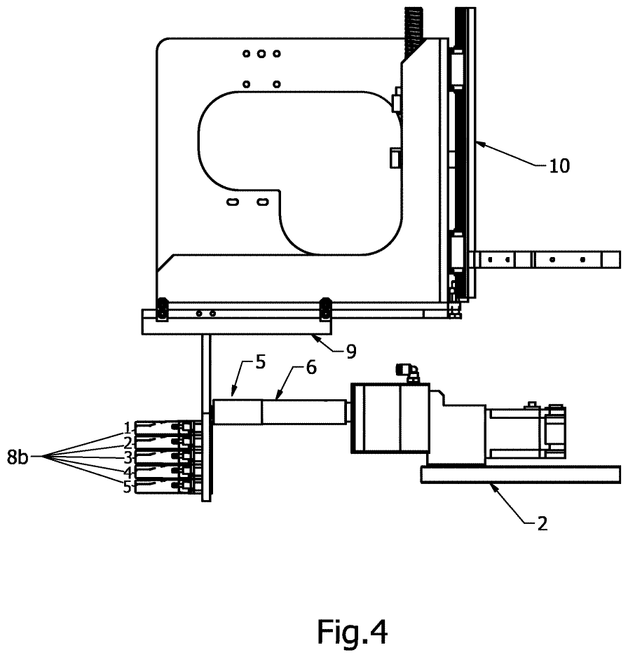

FIG. 4 shows a side-up view of the second printing station in FIG. 3 with the carriage in a lowered position assumed after the print was made;

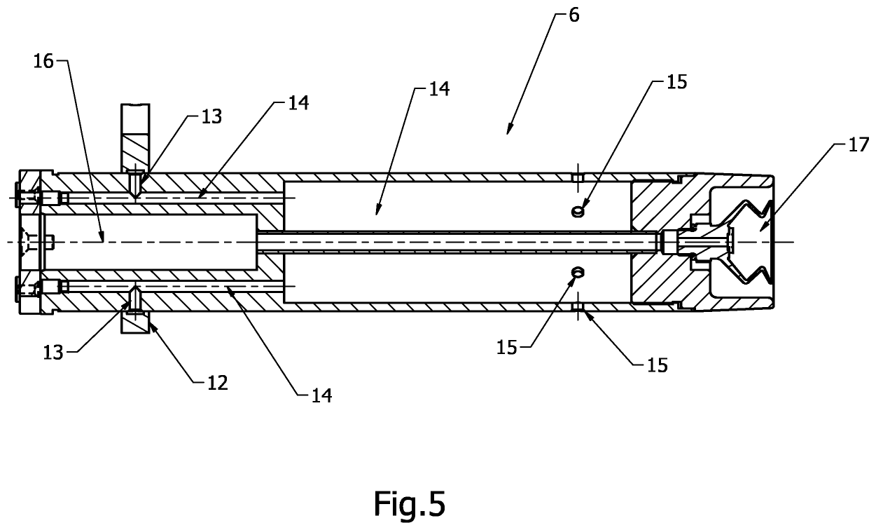

FIG. 5 shows a plan view of an axially sectioned spindle;

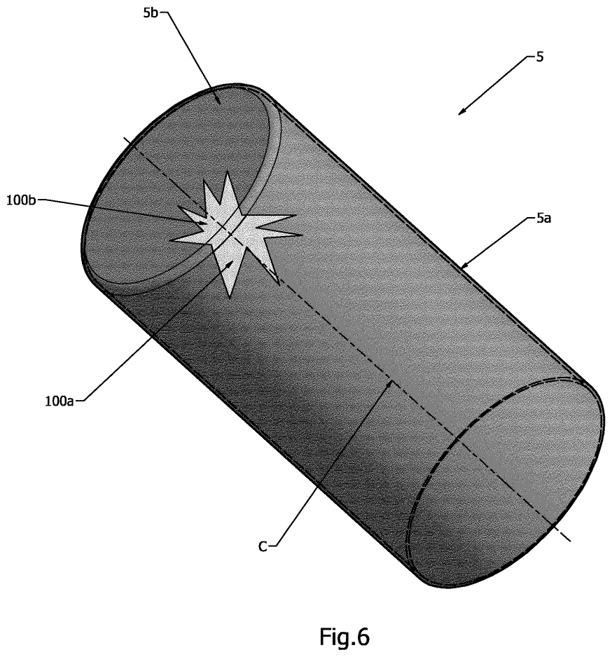

FIG. 6 shows a capsule after printing;

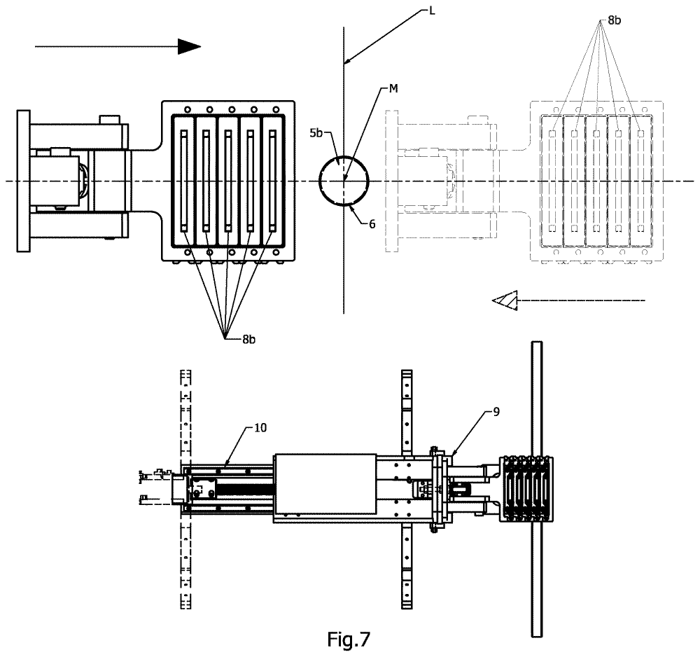

FIG. 7 is a frontal view of a second printing station according to another design in which the second printhead(s) are moved horizontally while the capsule is stationary at the second printing station;

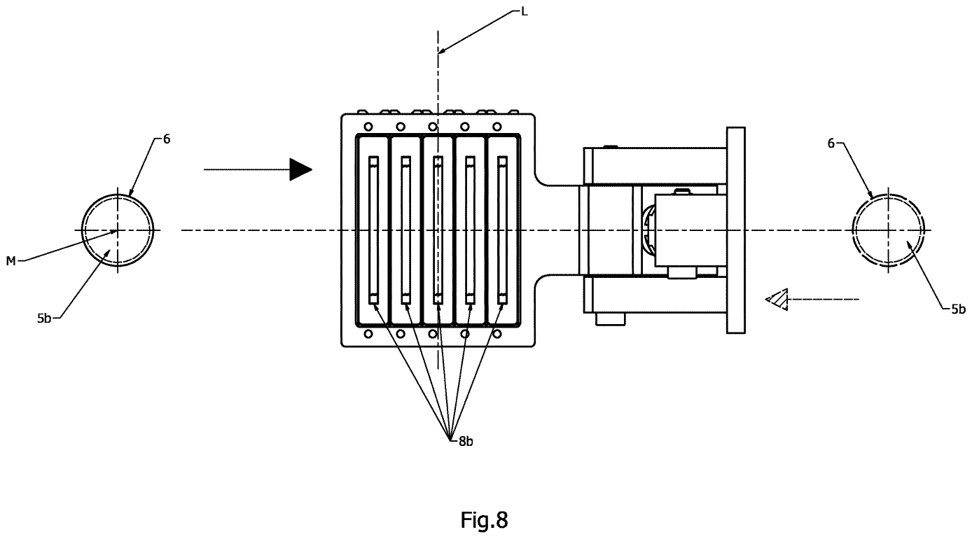

FIG. 8 is a front view of a second printing station in another manner in which one or more second printheads are stationary while the capsule passes through the second printing station.

With reference to the above-mentioned figures, an ink-jet digital printing machine 1 is shown for printing on the outer surfaces of capsules 5 generally presenting rotational symmetry around an axis C.

Capsules 5 in particular are of the type with a tubular mantle 5a and a closing head 5b closing one end of the tubular mantle 5a.

The tubular mantle 5a may, for example, be entirely cylindrical in shape or comprise cylindrical sections.

The closing head 5b can be flat, concave, convex or have bas-reliefs or high-reliefs.

Capules 5 can be for various purposes, e.g. caps and in particular screw caps for bottles, with a smooth or even already rolled mantle 5a.

Machine 1 comprises a frame supporting one or more first printing stations 4a for printing on the mantle 5a of the capsule 5, one or more second printing stations 4b for printing on the closing head 5b of the capsule 5, and a rotary table 2 for sequential transport of the capsule 5 through the printing stations 4a, 4b.

Table 2 can be rotated in steps around a rotation axis L and supports one or more spindles 6 for supporting capsules 5.

The rotation axis L of table 2 is preferably vertical.

Spindles 6 are positioned at a defined, in particular constant, angular distance around the rotation axis L of table 2.

Each spindle 6 has an axis M radially oriented with respect to the rotational axis L of table 2 and is driven in rotation on its own axis M by a special motor.

Each spindle 6 has an internal suction to clamp the capsule 5 on spindle 6.

Capsule 5, if ferromagnetic, can also be clamped on spindle 6 by a magnetic clamping element. Printing stations 4a, 4b are positioned along the circular path of spindles 6.

The printing stations 4a, 4b are positioned at a defined angular distancing step around the rotation axis L of the table 2, in particular equal to or a multiple of the angular distancing step of the spindles 6.

Each printing station 4a, 4b is equipped with one or more printheads 8a, 8b.

Table 2 is, as mentioned, rotatable in steps for sequential transfer of spindles 6 with capsules 5 at printheads 8a, 8b of printing stations 4a, 4b.

The electronic controller of the printing machine 1 is programmed to drive the spindle 6 stationed at each of the one or more first printing stations 4a in rotation about its axis M in order to execute a print 100a on the mantle 5a of the capsule 5 by means of the one or more first printheads 8a.

The one or more first printheads 8a are specially oriented to face the tubular mantle 5a of the capsule 5 so that the longitudinal axis of the one or more first printheads 8a is parallel to the axis of the spindle 6.

More precisely, the electronic controller drives the spindle 6 with a constant angular speed for at least one rotation of 360° in such a way as to make the mantle 5a of the capsule 5 integral with the spindle 6 complete a rotation of 360° thus expose the entire development of the outer surface of the shroud 5a of the capsule 5 to the one or more first printheads 8a of each first printing station 4a.

The one or more first printheads 8a of each first printing station 4a can be adjusted in position individually and collectively before printing is performed.

The electronic controller of the printing machine is also programmed to lock the rotation of the spindle 6 about its axis M at each of the one or more second printing stations 4b in order to execute a print 100b on the closing head 5b of the capsule 5 by means of the one or more second printheads 8b.

The spindle 6 may have pressurised air delivery means configured to bring air into the gap between the inner surface of the capsule and the outer surface of the spindle 6. In this way, the volume of air in contact with the inner surface of the mantle 5a of the capsule 5 is maintained in slight overpressure to prevent ink droplets, ejected from the heads or floating in the air (overspray) from accidentally polluting the inner surface of the capsule 5.

The first 4a prining stations are preferably each dedicated to the application of a different print colour.

The second printing stations 4b are preferably each dedicated to the sequential application of several print colours.

The electronic controller always knows the angular position of the spindle 6 around its axis M and consequently also automatically knows the angular position of the print on the tubular mantle 5a of the capsule 5 as it is deterministically linked to the known angular position of the spindle 6: the print 100a on the closing head 5b of the capsule 5 with respect to the print 100b on the tubular mantle 5a of the capsule 5 can therefore be oriented without the need for the implementation of dedicated sensors to recognise the angular position of the print 100a on the mantle 5a of the capsule 5.

The same applies if you first print 100b on the closing head 5b of capsule 5 and want to orientate the subsequent print 100a on the mantle 5a of capsule 5.

The one or more first printheads 8a of each first printing station 4a are preferably oriented horizontally and are positioned above the spindle 6 for printing.

The one or more first printhead(s) 8a of each first printing station 4a are programmed to print when stationary, as mentioned above, while the one or more second printhead(s) 8b of each second printing station 4b are programmed to print when stationary or when in motion.

When printing stationary (FIG. 8), the one or more second printheads 8b of each second printing station 4b print as the spindle 6 passes through the second printing station 4b with the capsule 5.

In this case, the one or more second printheads 8b are ordered in a row orthogonal to the axis L of table 2 and have a longitudinal axis parallel to the axis L of table 2.

The second printheads 8b in this case during the rotation of the table 2 sweep the entire surface of the closing head 5b of the capsule 5 in succession to execute the print.

The transit of spindle 6 through the second printing station 4b takes place with table 2 driven at constant angular speed.

In the case of printing in motion (FIGS. 3, 4 and 7), the one or more second printheads 8b of each second printing station 4b print while the spindle 6 is stationed with the capsule 5 at the second printing station 4b.

In the case of printing in motion, the one or more second printheads 8b of each second printing station 4b print while performing a horizontal or vertical linear movement.

With reference to the solution shown in FIGS. 3 and 4, the second printheads 8b are arranged in a vertical row of parallel second printheads 8b having a horizontal longitudinal axis and are moved vertically by a motorised carriage 9 sliding along a fixed vertical guide 10.

The second printheads 8b are positioned at rest above the spindle 6 and during a downward stroke of the carriage 9 sweep in succession from top to bottom the entire surface of the closing head 5b of the capsule 5 for the execution of the print 100b, and at the end of the print they return to the rest position by an upward stroke of the carriage 9.

In a possible variant (not shown), the second printheads 8b are positioned at rest under the spindle 6 and during an upward stroke of the carriage 9 sweep in succession from bottom to top the entire surface of the closing head 5b of the capsule 5 for the execution of the print 100b, and at the end of the print they return to the rest position by means of a downward stroke of the carriage 9.

In a possible variant (FIG. 7), the second printheads 8b are arranged in a horizontal row of parallel second printheads 8b having a vertical longitudinal axis and are moved horizontally by a motorised carriage 9 sliding along a fixed horizontal guide 10.

In this case, the second printheads 8b are positioned at rest to the right or left of the spindle 6 with the capsule 5 and during a horizontal stroke from right to left or vice versa of the carriage 9 sweep successively from right to left or vice versa the entire surface of the closing head 5b of the capsule 5 for the execution of the print 100b, and at the end of the print they return to the rest position by means of a horizontal opposite stroke of the carriage 9.

The workstations of printing machine 1 can vary in number and functions, depending also on the size of printing machine 1.

In the case shown as an example only, there is, in the direction of rotation of table 2, a sequence of first printing stations 4a, one dedicated to printing white and the next dedicated to printing a different colour, and a sequence of two second printing stations 4b, one dedicated to printing white and the next dedicated to sequential printing of all colours.

There may be stations 4e for drying the ink or other material deposited on the capsule 5, stations 4f for applying a glossy coating, stations 4g for applying a primer, stations 4h for inspecting the print quality, stations (not shown) for inspecting the cleanliness of the outer surface of the spindles 6, etc., as well as, of course, a loading station 4c for the capsule to be processed and an unloading station 4d for the processed capsule.

The print quality inspection stations 4h can comprise a print quality inspection station on the mantle 5a and a print quality inspection station 4h on the locking head 5b.

The electronic controller performs the inspection by preliminarily acquiring with an optical sensor an image of a reference capsule showing a correctly executed print and comparing it with the image of the reference capsule with the image of the freshly processed capsule 5 acquired by the same optical sensor at the same position as the reference capsule.

Specifically, in one inspection station an optical sensor has a field of view on the mantle 5a of capsule 5, and in a further inspection station a further optical sensor has a field of view on the closing head 5b of capsule 5 for total control of print quality.

In the spindle cleaning inspection station 6, the electronic controller performs the inspection by preliminarily acquiring with an optical sensor an image of a reference spindle 6 devoid of capsule 5 and clean and comparing with the image of the reference spindle the image of the spindle from which the newly processed capsule was unloaded acquired by the same optical sensor at the same position of the reference spindle.

As mentioned above, some of the workstations may be operational during the rotary movement of table 2 while other stations may be operational when table 2 is stationary.

Printing machine 1 is preferably of the single-pass type for the application of each colour.

Therefore, depending on the size of capsule 5, it may be necessary to have several printheads aligned for the application of each colour in order to cover the entire surface to be printed with a single pass of the printheads.

The printing process takes place as follows.

Once the preliminary adjustments have been completed, table 2 is operated, whose spindles 6 are supplied with capsules 5.

Table 2 is rotary-operated in steps and stations 4a-4h, operate sequentially on each capsule 5, during the idle time of table 2.

Eventually, as mentioned, some stations may operate during the operation of table 2.

In this way, for the same printing machine size, in particular the same table diameter 2, more functions can be implemented and consequently more complex decorations can be executed with greater versatility.

The digital inkjet capsule printing machine thus conceived is susceptible to numerous modifications and variations, all of which are within the scope of the inventive concept; moreover, all details are replaceable by technically equivalent elements.

In practice, the materials used, as well as the dimensions, can be any according to requirements and the state of the art.

1. A digital inkjet printing machine for printing on at least one capsule formed by a tubular mantle and a closing head, and further comprising an electronic controller, a conveyor table, at least a first printing station provided with at least a first printing head dedicated to printing on said tubular mantle and at least a second printing station provided with at least a second printing head dedicated to printing on said closing head, wherein said conveyor table is programmed to rotate in steps around a rotation axis and supports at least one support spindle of said at least one capsule, wherein said at least one support spindle has an axis oriented radially with respect to said rotation axis of said conveyor table, wherein said conveyor table is configured to convey said at least one spindle at said at least a first printing station and at said at least a second printing station, wherein said controller is programmed to drive rotatingly about its axis said at least one spindle stationing at said at least a first printing station, and to block the rotation about its axis of said at least one spindle at said at least a second printing station.

2. The digital inkjet printing machine according to claim 1, characterized in that said controller is programmed to clamp a capsule on said at least one spindle, to drive rotatingly about its axis said at least one spindle stationing at said at least a first printing station with the clamped capsule threon and, after said at least one spindle with the clamped capsule is conveyed from said first printing station to said second printing station, to block the rotation aboutits axis of said at least one spindle with the clamped capsule threon at said at least a second printing station.

3. The digital inkjet printing machine according to claim 1, characterized in that said controller employs the angular position of said at least one spindle known from a program for rotatingly driving said at least one spindle about its axis in order to orient the print on the closing head with respect to the print on the tubular mantle or vice versa.

4. The digital inkjet printing machine according to claim 1, wherein said conveyor table has a vertical rotation axis

5. The digital inkjet printing machine according to claim 1, wherein said at least a first head is horizontally oriented.

6. The digital inkjet printing machine according to claim 1, wherein said at least a first head is programmed to print while stationary and said at least a second head is programmed to print while stationary or in motion.

7. The digital inkjet printing machine according to claim 1, wherein said at least a second head is programmed to print while stationary when said at least one spindle is in transit through said second printing station.

8. The digital inkjet printing machine according to claim 6, wherien said at least a second head is programmed to print while in motion when said at least one spindle is stationing in said second printing station.

9. The digital inkjet printing machine according to claim 1, wherein said at least a second head is programmed to print during the execution of a horizontal or vertical linear movement.

10. The digital inkjet printing machine according to claim 1, wherein said at least one spindle has pressurized air delivery means.

11. The digital inkjet printing machine according to claim 1, further comprising a station for optical inspection of the printing quality on the capsule and/or a station for optical inspection of the cleaning of the external surface of said at least one spindle.
